(19) United States
(12) Patent Application Publication
(10) Pub. No.: US 2011/0289832 A1
(43) Pub. Date: Dec. 1, 2011

(54) SYSTEM AND METHOD FOR LAWN CARE

(75) Inventor: Thomas John Kelly, Mount Vernon, NH (US)

(73) Assignee: Fire Belly Organic Lawn Care, Milford, NH (US)

(21) Appl. No.: 12/789,000

(22) Filed: May 27, 2010

(51) Int. Cl. A01G 1/00

(52) U.S. Cl. 47/1.5; 47/58.1 SC

(57) ABSTRACT

The present invention features a multi-step organic lawn care program that comprises four or more specified treatments that are applied at specific times throughout the year. Each step serves specific functions that assist in the maintenance and improvement of turf. Each treatment is intended to be applied at a prescribed time to ensure maximum benefits to the turf. The treatments are preferably applied in a liquid format are generally effective at detoxifying a surface that has been treated with chemical fertilizers. The treatments may be applied in conjunction with other products.

### TECHNICAL FIELD

The present invention relates to a system and method of lawn care and more particularly, to an organic multi-step lawn treatment system and method that utilizes specific product application, application rates and application time frames, which provides for a comprehensive lawn care program.

### BACKGROUND

Traditional lawn care products includes pesticides, fertilizers and fungicides. These products have been primarily chemical in nature. Over the years, those concerned with the environment as well as consumers of lawn care products have become increasingly aware of the toll that these chemical products take on lawns, the environment, and on people and household pets. Pesticides have the ability to move around in the environment and people can be exposed to them even if they are not using the pesticides. For example, Atrazine is one of the most frequently detected pesticides in drinking water in the United States. When lawns are covered with pesticides, it is important to consider the dangers to families, especially children, who are more sensitive to developmental disruption. Pesticides are created from a wide range of chemicals and each has a different mode of action, so the list of potential problems and health risks is extensive.

The use of pesticides in lawns has also been shown to end up directly in lakes, streams and groundwater, from which drinking and irrigation water is drawn. This run off or percolation occurs from household lawns and gardens, commercial farms, as well as golf courses and other applications. Any water-soluble material applied to turf will either run off (in excessive rain) or percolate down through the soil into the groundwater.

Many lawn chemicals persist for long periods in soil and water, and synthetic (chemical) fertilizers use much more soluble forms of nitrogen (and phosphorus) than organic fertilizers, and thus there is an increased risk of groundwater pollution. Groundwater pollution is a very serious issue in communities that draw their drinking water from those sources. Additionally, the chemicals and fertilizers applied to turf also migrate into the air that we breathe. Pesticides and other chemicals often do become airborne and they can be transferred to our clothing, to our pets, and into our homes. The dangers of chemical pesticides are well known and well documented. However, people still want to be able to maintain a green lawn and healthy plants.

In order to eliminate the harmful affects of pesticides, organic lawn care has become increasingly popular. One of the core principles of organic lawn and garden care is that the health of the soil microbial community is the key to the health of the plant's growing in that soil and the health of the organisms that depend on them. The relations between soil health and the ability to resist erosion run-off is one key to environmental advantages of organic turf management. The Soil Food Web depicts the relationship between the soil, organic matter, plants, insects, mammals, birds, and all other participants that make up the soil environment. Today there are a multitude of organic products on the market. Many of these products are targeted at particular plants or particular problems. There does not exist a comprehensive, multi-step organic lawn care program that is safe and effective.

As such, there is a need to improve upon prior chemical methods and systems of treating lawns in order to create a method and system that is safe and effective. The products and methods should be user-friendly, safe, and easy to apply. The process should be simplified such that a lawn can be treated organically in a simple turf care program that is free of dangerous chemical processes, easy to use and apply, and effective as well.

### SUMMARY OF THE INVENTION

The present invention features a multi step organic lawn care method and process. The system realizes that the plants want to grow and that the best method to ensure their growth is to give them ideal conditions for growth. The system involves two basis principles: take care of the soil and the micro-organisms that live in it, and chose appropriate plants (grass or otherwise) to grow in the soil.

The products should always be environmentally responsible products that address soil biology. The program disclosed herein utilizes horticultural products that feed the soil through the introduction of select beneficial microbial species allowing them to facilitate the natural processes inherent to healthy plant growth. The products blend a diverse array of beneficial soil microorganisms with natural plant extracts and organic nutrients to create microbial systems. These natural systems simultaneously feed the soil and the plant, which allows plants to grow to their full genetic potential.

The system consists of liquid foliar concentrates combined with a proprietary program that will simplify the entire process of making the switch to using organic methods when it comes to lawn care. The products and programs address soil biology thereby providing the end user with a competitive advantage over traditional organic products. In order for plants to thrive in the face of environmental extremes the soil profile supporting that plant must contain a diverse population of beneficial soil microorganisms. These microscopic microorganisms improve nutrient availability, enhance nutrient absorption, reduce the incidence of nutrient leaching, stimulate healthy plant growth, improve the soil structure and provide plants with increased resistance to environmental extremes such as drought, heat, cold and foot traffic.

The system implements a comprehensive organic program that addresses soil biology and ensures success. The products introduce select beneficial microbial species allowing them to facilitate the natural processes inherent to healthy plant growth. The program blends a diverse array of beneficial soil microorganisms with natural plant extracts and organic nutrients to create microbial systems. These natural systems simultaneously feed the soil and the plant, which allows plants to grow to their full genetic potential. Superior results are created when the specifically formulated products are used in conjunction with one another over the course of a full year. These incredible results are all accomplished without the use of synthetic fertilizers or dangerous pesticides. All of the products are extremely easy to apply and begin to go to work right away.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention.

### DESCRIPTION OF THE PREFERRED EMBODIMENT OF THE INVENTION

The system and method of organic lawn care maintenance according to the present invention is a grouping of products that are applied over the course of a year to plant growth such as a lawn or other turf application. The products work in conjunction with one another to deliver superior results. The system is comprised of a minimum of four applications, and can include six or more application of specially and specifically selected products applied at generally specific times of the plant growth cycle. The system can also be effective to a lesser degree when using less than four of the prescribed applications of products.

In one embodiment, the system utilizes six steps. Each step uses a different product that embodies a treatment that is specific for the time of year and the plant's growing cycle. As an example, a first treatment will be a Spring Growth Activator. This first treatment will awaken the soil and feed the soil with beneficial soil microorganisms, humic acid, kelp, amino acids, vitamins, biotin, folic acid and natural sugars. A second treatment will be a Biologically Enhanced Spring Fertilizer. This second treatment will address the quality of the turf and the health of the soil with 54 strains of beneficial soil bacteria and naturally occurring macro-nutrients.

A third treatment will be a Mid Season Kelp Spray. This third treatment will prepare the lawn and soil for the stress of summer with a formulation that contains natural plant growth compounds, amino acids, micro nutrients and vitamins. A fourth treatment will be a Summer Saver Bio Fertilizer. This fourth treatment will contain a chelated microbial fertilizer that will address all the needs of the turf as temperatures rise and water is less available.

A fifth treatment will be Late Season Organic Growth Compound. This fifth treatment will be a biologically active organic fertilizer that simultaneously addresses turf vigor and soil biology, which addresses root development in the fall. A sixth treatment will be Winterizing Humates. This sixth treatment utilizes potassium humate and amino acids to harden off turf cell structure to protect the turf from winter extremes while also providing a natural source of nitrogen that will feed the turf for improved color and growth in the spring.

The six steps are applied at specific times during the year. Although application will vary across planting zones and regions and in various growing conditions, the application of the six steps will generally fall into the range of early spring (step 1), late spring (step 2), early summer (step 3), late summer (step 4), early fall (step 5), and late fall (step 6).

As an example, the customer may be given the following application guideline: March 15-April 30 (step 1), May 1-June 15 (step 2), June 16-July30 (step 3), August 1-September 15 (step 4), September 16-October 30 (step 5), November 1-December 15 (step 6). The products should be applied in approximately six week intervals.

The first step, also known as the Spring Growth Activator is an all natural product which is specifically formulated to stimulate microbial activity in the soil and allow turf to come out of dormancy with vigor. The first step contains 54 strains of beneficial soil micro-organisms, humic acid, kelp, essential amino acids, vitamins, biotin, folic acid and natural sugars. The beneficial microbial populations and natural ingredients provide the soil with the necessary components to promote healthy growth and provide resistance to environmental extremes that can be associated with turf strength, color and vigor.

The Spring Growth Activator will minimize nutrient leaching, aid in nutrient cycling and absorption, improve soil structure, make existing nutrients more available to turf, enhance seed germination and stimulate plant growth. By utilizing Spring Growth Activator there is no need to apply high nitrogen chemical fertilizers to create lush spring growth and color.

The preferred embodiment of the Spring Growth Activator may include the following components: bacillus & paenibacillus (bacteria) 39 strains, pseudomonas (bacteria) 6 strains, streptomyces (actinomycetes) 5 strains, trichoderma (fungi) 4 strains, amino acids derived from soy meal, vitamins derived from yeast, humic acid, kelp, and natural sugars. The Spring Growth Activator is ideal for the first treatment of the year when it comes to an organic lawn care program, but it also has benefits that can be realized anytime of year. The components and ingredients in this foliar concentrate can detoxify lawns that have been heavily treated with chemical fertilizers and dangerous pesticides by breaking down and decomposing chemical residues. Secondly, the added bacterial strains and kelp ingredients are a perfect combination for a replacement of a chemical starter fertilizer. These ingredients will aid in seed germination and stimulate the rooting process of new seedlings when they emerge.

The second step, also known as the Biologically Enhanced Spring Fertilizer is a Bio-Tilth spray for lawns that is intended to be applied in conjunction with or soon after the Spring Growth Activator. The Biologically Enhanced Spring Fertilizer is a biologically enhanced specialty fertilizer. It simultaneously addresses soil health and plant nutrition by not only feeding the turf with macro-nutrients but also builds soil health by introducing highly beneficial soil microorganisms. The nutrients in this foliar concentrate are chelated, which means that they are immediately available to the grass plants and will not leach or photo-degrade. By using a liquid formulation, the nutrient portion of this product is immediately absorbed into the tissue of the grass plant meaning quicker results and reaction.

The Biologically Enhanced Spring Fertilizer has a guaranteed analysis that typically includes the following: Total Nitrogen (N) 7.0%, 6.5% Water Soluble Nitrogen, 0.5% Water Insoluble Nitrogen, Available Phosphate (P205) 1.0%, Soluble Potash (K20) 2.0%, Bacillus subtilis 20,000,000 CFU per ml, Bacillus licheniformis, 10,000,000 CFU per ml, Bacillus pumulis 10,000,000 CFU per ml, Bacillus coagulans 10,000,000 CFU per ml, Bacillus megaterium 10,000,000 CFU per ml, Bacillus azotoformans10,000,000 CFU per ml, Paenibacillus polymyxa 10,000,000 CFU per ml, Paenibacillus durum 10,000,000 CFU per ml, and 4.0% potassium humate (lignite).

The Biologically Enhanced Spring Fertilizer should be applied four to six weeks after applying the Spring Growth Activator. The Spring Growth Activator will cause the microorganisms in the soil to begin to flourish and allow the macronutrients in the Biologically Enhanced Spring Fertilizer to be utilized much more easily by the turf. There is no need to over fertilize with chemical fertilizers that tend to leach into ground water. The soil is feeding the turf not just the active ingredients in the treatment.

The third step, also known as Mid Season Kelp Spray prepares the turf for dealing with the stress of summer conditions. This step is often overlooked in many lawn care programs. Turf is a living thing and will take specific measures to conserve energy, nutrients and moisture when it begins to feel this stress. If conditions become extreme it will go dormant. The Mid Season Kelp Spray will not only reduce the impact of summer stress on turf it will continue to build a healthy lawn. This environmentally friendly formulation contains natural plant growth compounds, amino acids, micro -nutrients and vitamins, which creates a unique natural growth stimulant.

The Mid Season Kelp Spray typically contains the following components: Total Nitrogen (N) 0.10%, Ammoniacal Nitrogen 0.10%, Available Phosphate (P2 05) 0.10%, Soluble Potash (K20) 0.50%, nutrients derived entirely from ecklonia maxima (Giant Sea Kelp) and non plant food ingredients including 1.0% Carbohydrates, 0.2% Protein, 0.1% Amino Acids, and 0.05% Vitamins (B1, B2, C, E).

The Mid Season Kelp Spray provides numerous agricultural benefits when the kelp is processed properly. The use of kelp (or seaweed) increases yields and builds soil health. When it comes to turf, one of the most important benefits of kelp is it's ability to increase chlorophyll production within the plant. This creates a deeper and darker color of green in turf. It also increases root mass and development meaning the turf absorbs and utilizes water and nutrients much more effectively.

The fourth step, also known as the Summer Specialty Fertilizer, addresses the stress on the lawn as a result of the summer months in all types of climates. The Summer Specialty Fertilizer is a microbial fertilizer that is made up of amino acids which address the immediate nutritional requirements of plants providing them with a quick, readily available source of primary nutrients even as temperatures increase and water becomes less available. The added strains of bacteria continue to address the soil food web in order to build structure and develop ever-important microbial activity.

The Summer Specialty Fertilizer typically includes an analysis that may contain: Total Nitrogen (N) 7.0%, Water Soluble Nitrogen 6.5%, Water Insoluble Nitrogen 0.5%, Available Phosphate (P205) 1.0%, Soluble Potash (K20) 2.0%, Bacillus subtilis 20,000,000 CFU per ml, Bacillus licheniformis, 10,000,000 CFU per ml, Bacillus pumulis 10,000,000 CFU per ml, Bacillus coagulans 10,000,000 CFU per ml, Bacillus megaterium 10,000,000 CFU per ml, Bacillus azotoformans 10,000,000 CFU per ml, Paenibacillus polymyxa 10,000,000 CFU per ml, Paenibacillus durum 10,000,000 CFU per ml, and 4.0% potassium humate (lignite).

The Summer Specialty Fertilizer provides many benefits in addition to the beneficial microbial species and nutrients. The Summer Specialty Fertilizer also contains kelp, humic acid, and potassium humate. When the soil and turf need it the most this product supplies all of the necessary inputs to promote turf vigor, growth and color. Summer conditions and chemical fertilizers can be dangerous combination. When high levels of nitrogen and phosphorus are applied to dry soil they are often immediately leached into ground water and street drains during thunderstorms. When chemical fertilizers are replaced by liquid foliar concentrate sprays, there is an immediate impact on the environment.

The fifth step, also known as Late Season Bio-Fertilizer, is a Bio-Tilth for Lawns that provides for root development, which is key late in the season. The microbial portion of the product allows for the development of a symbiotic relationship with the microorganisms and the root system of the lawn. Roots provide the microorganisms with a readily available source of life sustaining carbon and in return they protect and nourish the roots. This interplay is an integral part of microbial establishment and it allows plants to grow and develop to their full genetic potential. The microbial species contained in this foliar concentrate will enhance nutrient absorption, improve nutrient availability and reduce the incidence of leaching. The Late Season Bio-Fertilizer will also continue to feed the turf with nutrients and vitamins.

The Late Season Bio-Fertilizer typically includes an analysis that generally contains: Total Nitrogen (N) 7.0%, Water Soluble Nitrogen 6.5%, Water Insoluble Nitrogen 0.5%, Available Phosphate (P205) 1.0%, Soluble Potash (K20) 2.0%, Bacillus subtilis 20,000,000 CFU per ml, Bacillus licheniformis, 10,000,000 CFU per ml, Bacillus pumulis 10,000,000 CFU per ml, Bacillus coagulans 10,000,000 CFU per ml, Bacillus megaterium 10,000,000 CFU per ml, Bacillus azotoformans 10,000,000 CFU per ml, Paenibacillus polymyxa 10,000,000 CFU per ml, Paenibacillus durum 10,000,000 CFU per ml, and 4.0% potassium humate (lignite).

The Late Season Bio-Fertilizer builds a strong “food web” within the structure of the soil from which turf grows, which is really the ultimate goal of an organic lawn care program. This product goes way beyond what is considered to be a typical organic lawn treatment. The addition of a concentrated and diverse biological component makes this much more than just an organic fertilizer.

The sixth step, also known as the Winterizer, is a foliar concentrate that serves two extremely important functions when it comes to the success of an organic lawn. Primarily it contains potassium humate, which will improve the cell structure of grass and harden off the turf. The Winterizer provides turf with essential metabolites thus enhancing nutrient uptake and promoting microbial growth and proliferation. As temperatures fall, the microbial activity slows down in the soil and the Winterizer will give one last boost that will allow for an improved soil profile when the turf begins to flourish again in spring. Secondly, this amino acid based formulation feeds the turf by providing a readily available source of nitrogen.

The Winterizer components include a guaranteed analysis that may contain Total Nitrogen (N) 3.0%, Water Soluble Nitrogen 3.0%, nutrients derived from Protein Hydrolysate (Amino Acids) and non plant food ingredients including potassium humate 5.0%.

The Winterizer foliar concentrate is essentially a plant and soil stimulator. The Winterizer does everything a typical chemical winterizer would do, but additionally supplies beneficial nutrition to the grass and continues to stimulate biological activity in the soil, such that the Winterizer could be used anytime of the year to simply make the soil and turf stronger. The Winterizer is the ideal treatment for the final application of the year.

In another embodiment of the present invention, four products would be used. In this embodiment, the application would consist of the following applications of products: Spring Growth Activator, Summer Fertilizer, Late Season Fertilizer and Winterizer. In this example, the customer may be given the following application guideline: March 15-April 30 (Spring Growth Activator), June 16-July 30 (Summer Fertilizer), September 16-October 30 (Late Season Fertilizer), November 1-December 15 (Winterizer).

In other embodiments of the invention, the method and process of applying four, five, six or more steps may be used in conjunction with additional products or multiple applications of one or more of the products described herein. The additional products may be designed to target a specific problem or to encourage a specific result. The additional products may also be targeted to a specific growing location and may include an analysis of the type of soil, type of turf, and the weather, as well as other factors that are present at a specific location to determine an effective program of treatment. For example, in one embodiment of the present invention, a weed preventative may be applied in the spring or as necessary. The weed preventative would be an organic product and may be comprised of corn gluten.

Modifications and substitutions by one of ordinary skill in the art are considered to be within the scope of the present invention.

1. A four-step organic lawn care program for application to turf, wherein said multi-step organic lawn care program comprises:
a first liquid treatment, wherein said first liquid treatment is applied during the spring;
a second liquid treatment, wherein said second liquid treatment is applied during the summer;
a third liquid treatment, wherein said third liquid treatment is applied in the early fall; and
a fourth liquid treatment, wherein said fourth liquid treatment is applied in the late fall.

2. The multi-step organic lawn care program of claim 1 wherein:
said first liquid treatment is a foliar concentrate that further comprises soil micro-organisms, humic acid and kelp, wherein said first liquid treatment is capable of detoxifying a lawn that has been treated with chemicals;
said second liquid treatment is a microbial fertilizer that further comprises amino acids, wherein said amino acids provide a source of nutrients to a lawn during summer months when temperatures increase and water becomes less available;
said third liquid treatment is a bio-tilth foliar concentrate that further comprises carbon, wherein said third liquid treatment provides for root development; and
said fourth liquid treatment is a foliar concentrate that further comprises potassium humate and nitrogen, wherein said fourth liquid treatment improves the cell structure of the lawn and protects the turf for the winter months.

3. The multi-step organic lawn care program of claim 1, further comprising the application of a weed preventative, wherein said weed preventative is made from corn gluten.

4. The multi-step organic lawn care program of claim 1, further comprising a fifth liquid treatment, wherein said fifth liquid treatment is a chelated foliar concentrate with macro-nutrients and microorganisms that is applied in conjunction with said first liquid treatment or shortly after said first liquid treatment.

5. The multi-step organic lawn care program of claim 4 further comprising a sixth liquid treatment, wherein said sixth liquid treatment is a kelp spray that is applied after said first liquid treatment and before said second liquid treatment.

6. A method of applying an organic turf care program to a turf area, comprising the acts of:
applying a first organic liquid treatment to a turf area, wherein said first organic liquid treatment is applied in the spring;
applying a second organic liquid treatment to said turf area, wherein said second organic liquid treatment is applied after said first organic liquid treatment;
applying a third organic liquid treatment to said turf area, wherein said third organic liquid treatment is applied after said second organic liquid treatment; and
applying a fourth organic liquid treatment to said turf area, wherein said third organic liquid treatment is applied after said third organic liquid treatment.

7. The method of claim 6, further comprising the act of:
applying a fifth organic liquid treatment to said turf area, wherein said fifth organic liquid treatment is applied in conjunction with said first organic liquid treatment or after said first organic liquid treatment.

8. The method of claim 7, further comprising the act of:
applying a sixth organic liquid treatment to said turf area, wherein said sixth organic liquid treatment includes a kelp spray.

9. The method of claim 6, further comprising the act of:
applying an organic weed preventative to said turf area, wherein said weed preventative is made from corn gluten.

10. The method of claim 6, wherein:
said first liquid treatment is a foliar concentrate that further comprises soil micro-organisms, humic acid and kelp, wherein said first liquid treatment is capable of detoxifying a lawn that has been treated with chemicals;
said second liquid treatment is a microbial fertilizer that further comprises amino acids, wherein said amino acids provide a source of nutrients to a lawn during summer months when temperatures increase and water becomes less available;
said third liquid treatment is a bio-tilth foliar concentrate that further comprises carbon, wherein said third liquid treatment provides for root development; and
said fourth liquid treatment is a foliar concentrate that further comprises potassium humate and nitrogen, wherein said fourth liquid treatment improves the cell structure of the lawn and protects the turf for the winter months.

11. The method of claim 7, wherein said fifth liquid treatment is a chelated foliar concentrate with macro-nutrients and microorganisms that is applied in conjunction with said first liquid treatment or shortly after said first liquid treatment.

12. The method of claim 8, wherein said sixth liquid treatment is a kelp spray that is applied after said first liquid treatment and before said second liquid treatment.
